(19) United States
(12) Patent Application Publication
(10) Pub. No.: US 2021/0274521 A1
(43) Pub. Date: Sep. 2, 2021

(54) METHOD, APPARATUS AND COMPUTER READABLE MEDIA FOR CONTROL SIGNAL TRANSMISSION AND RECEPTION

(71) Applicant: NEC CORPORATION, Tokyo (JP)

(72) Inventors: Fang YUAN, Beijing (CN); Gang WANG, Beijing (CN)

(73) Assignee: NEC CORPORATION, Tokyo (JP)

(21) Appl. No.: 17/253,410

(22) PCT Filed: Jun. 22, 2018
(86) PCT No.: PCT/CN2018/092517

§ 371 Date: Dec. 17, 2020

(51) Int. Cl. H04W 72/12; H04W 72/04; H04L 1/00

(52) U.S. Cl. CPC H04W 72/1263; H04W 72/1257; H04L 1/0004; H04W 72/0446; H04L 1/0038; H04W 72/0453

(57) ABSTRACT

Embodiments of the present disclosure relate to methods, apparatuses and computer program products for control signal transmission and reception in a wireless communication system. A method implemented at a network device comprises transmitting a first control message in a control resource region to a terminal device, the first control message having a predetermined size and including first configuration information for detecting a second control message; and transmitting the second control message in a data resource region to the terminal device, the second control message including information for scheduling a downlink or uplink data transmission for the terminal device.

### FIELD

Non-limiting and example embodiments of the present disclosure generally relate to a technical field of wireless communication, and specifically to methods, apparatuses and computer program products for control signal transmission and reception in a wireless communication system.

### BACKGROUND

This section introduces aspects that may facilitate better understanding of the disclosure. Accordingly, the statements of this section are to be read in this light and are not to be understood as admissions about what is in the prior art or what is not in the prior art.

In wireless systems, a terminal device transmits uplink traffic to a network device, and/or receives downlink traffic from the network device. Usually, both the uplink communication and downlink communication between the terminal device and the network device are controlled via scheduling information from the network device.

In a Long Term Evolution (LTE) network developed by the third generation partnership project (3GPP), the scheduling information may be carried in a downlink control indicator (DCI) in a physical downlink control channel (PDCCH). The PDCCH in LTE occupies first several Orthogonal Frequency Division Multiplexing (OFDM) symbols in a subframe.

Since PDCCH provides a limited capacity for control signal transmission and is not flexible with respect to interference control, new mechanisms for transmitting control signals including the scheduling information are desired.

### SUMMARY

Various embodiments of the present disclosure mainly aim at providing methods, apparatuses and computer program products for control signal transmission and reception in a wireless communication system.

In a first aspect of the disclosure, there is provided a method implemented at a network device. The method comprises transmitting a first control message in a control resource region to a terminal device, the first control message having a predetermined size and including first configuration information for detecting a second control message; and transmitting the second control message in a data resource region to the terminal device, the second control message including information for scheduling a downlink or uplink data transmission for the terminal device.

In some embodiments, the first configuration information may include at least one of: existence of the second control message, a search space for the second control message, an aggregation level for the second control message, a mode of the second control message, and a set of blind detection to be performed for the second control message. In some embodiments, the mode of the second control message may indicate at least one of: the number of transmit/reception points, TRPs, for which separate scheduling information is included in second control message, the number of uplink precoding groups supported by the second control message, the number of transport blocks scheduled by the second control message, the number of modulation and coding schemes indicated by the second control message, a set of blind detections to be performed for the second control message, a search space for detecting the second control message; and an aggregation level for the second control message.

In some embodiments, the first control message may include one or more bits for indicating the first configuration information.

In some embodiments, the method may further comprise transmitting semi-static second configuration information for the second control message to the terminal device. In some embodiments, the semi-static second configuration information for the second control message may comprise at least one of: a frequency and/or time location, a modulation and coding scheme, MCS, and a virtual resource to physical resource mapping.

In some embodiments, transmitting the first control message in a control resource region may comprise transmitting the first control message on a plurality of control channel elements (CCEs) in the control resource region, wherein an index of the first CCE of the plurality of CCEs indicates the first configuration information for detecting the second control message implicitly. In some embodiments, one of an odd index and an even index of the first CCE may indicate that the second control message is scheduled by the first control message, and the other of the odd index and the even index of the first CCE may indicate that a downlink or uplink data transmission is scheduled by the first control message.

In some embodiments, a result of the index of the first CCE modulo N may indicate one or both of: existence of the second control message, and a configuration for the second control message, wherein N is an integer larger than 2.

In some embodiments, the index of the first CCE of the plurality of CCEs may indicate the first configuration information for detecting the second control message implicitly, only when the first control message is transmitted in a predetermined control resource set.

In some embodiments transmitting the second control message in a data resource region may comprise transmitting the second control message on a plurality of resource units in the data resource region, wherein an index of the first resource unit of the plurality of resource units indicates a resource for a corresponding uplink feedback.

In some embodiments, the first control message may further include resource allocation information for the downlink or uplink data transmission for the terminal device.

In a second aspect of the disclosure, there is provided another method implemented at a network device. The method comprises transmitting a first control message in a first resource of a control resource region to a first terminal device; transmitting a second control message in a second resource of the control resource region to a second terminal device; and transmitting a third control message in a resource of a data resource region to the first terminal device via a first set of antenna ports; transmitting a fourth control message in the same resource of the data resource region to the second terminal device via a different second set of antenna ports; wherein each of the first control message and the second control message has a predetermined size and includes information for detecting the third control message and the fourth control message respectively; and wherein each of the third control message and the fourth control message includes information for scheduling a data transmission for the first terminal device and the second terminal device respectively.

In some embodiments, the third control message may indicate a first resource allocation for a data transmission for the first terminal device, and the fourth control message may indicate a second resource allocation for a data transmission for the second terminal device; the first resource allocation partially overlaps with the second resource allocation; and wherein the third control message indicates a first modulation and coding schemes, MCS, for the data transmission for the first terminal device in a first part of the first resource allocation overlapping with the second resource allocation, and a second MCS for the data transmission for the first terminal device in second part of the first resource allocation not overlapping with the second resource allocation.

In a third aspect of the disclosure, there is provided another method implemented at a network device. The method comprises transmitting a first control message in a control resource region to a terminal device, the first control message having a predetermined size which supports scheduling of two transport blocks for a downlink transmission, and including an configuration indication; transmitting downlink data using a first transport block of the two transport blocks based on scheduling information for the first transport block included in the first control message; and controlling a downlink transmission using a second transport block of the two transport blocks based on the configuration indication.

In some embodiments, controlling the downlink transmission using the second transport block of the two transport blocks based on the configuration indication may comprise: in response to the configuration indication having a first value, transmitting a second control message using the second transport block; and in response to the configuration indication having a second value, transmitting data using the second transport block.

In some embodiments, controlling the downlink transmission using the second transport block of the two transport blocks based on the configuration indication may comprise: in response to the configuration indication having a first value, transmitting a second control message using the second transport block; and in response to the configuration indication having a second value, preventing transmitting using the second transport block.

In a fourth aspect of the disclosure, there is provided another method implemented at a network device. The method comprises transmitting a first control message in a control resource region to a terminal device, the first control message having a predetermined size and including an configuration indication and a resource allocation; transmitting downlink data using a first part of the resource allocation; and controlling a downlink transmission using a second part of the resource allocation based on the configuration indication.

In some embodiments, controlling the downlink transmission using the second part of the resource allocation based on the configuration indication may comprise: in response to the configuration indication having a first value, transmitting a second control message using the second part of the resource allocation; and in response to the configuration indication having a second value, transmitting data using the second part of the resource allocation.

In some embodiments, controlling the downlink transmission using the second part of the resource allocation based on the configuration indication may comprise: in response to the configuration indication having a first value, transmitting a second control message using the second part of the resource allocation; and in response to the configuration indication having a second value, preventing transmitting using the second part of the resource allocation.

In a fifth aspect of the disclosure, there is provided a method implemented at a terminal device. The method comprises: receiving a first control message from a network device in a control resource region, the first control message having a predetermined size; obtaining first configuration information for detecting a second control message from the first control message; and detecting the second control message from the network device in a data resource region at least partly based on the obtained first configuration information, and detecting downlink data or transmitting uplink data based on the detected second control message.

In a sixth aspect of the disclosure, there is provided a method implemented at a terminal device. The method comprises: receiving a first control message from a network device in a control resource region, the first control message having a predetermined size; obtaining configuration information for detecting a second control message from the first control message, the configuration information indicating a set of antenna ports for detecting the second control message; and detecting the second control message transmitted via the set of antenna ports of the network device in a data resource region at least partly based on the obtained configuration information, and detecting downlink data or transmitting uplink data based on the detected second control message.

In a seventh aspect of the disclosure, there is provided a method implemented at a terminal device. The method comprises: receiving a first control message from a network device in a control resource region, the first control message having a predetermined size which supports scheduling of two transport blocks for a downlink transmission, and including an configuration indication; detecting a first transport block of the two transport blocks based on scheduling information for the first transport block included in the first control message; and controlling detection of a second transport block of the two transport blocks based on the configuration indication.

In an eighth aspect of the disclosure, there is provided a method implemented at a terminal device. The method comprises: receiving a first control message from a network device in a control resource region, the first control message having a predetermined size and including an configuration indication and a resource allocation; detecting downlink data in a first part of the resource allocation based on the received first control message; and controlling detection in a second part of the resource allocation based on the configuration indication.

In a ninth aspect of the present disclosure, there is provided a network device. The network device comprises at least one processor; and at least one memory including computer program codes; the at least one memory and the computer program codes are configured to, with the at least one processor, cause the network device at least to perform the method of any of the first to fourth aspects of the present disclosure.

In a tenth aspect of the present disclosure, there is provided a terminal device. The terminal device comprises at least one processor; and at least one memory including computer program codes; the at least one memory and the computer program codes are configured to, with the at least one processor, cause the terminal device at least to at least to perform the method of any of the fifth to eighth aspects of the present disclosure.

In an eleventh aspect of the disclosure, there is provided a computer program. The computer program comprises instructions which, when executed by an apparatus, causes the apparatus to carry out the method according to any the first to eighth aspect of the present disclosure.

In a twelfth aspect of the disclosure, there is provided a computer readable medium with a computer program stored thereon which, when executed by an apparatus, causes the apparatus to carry out the method of any the first to eighth aspect of the present disclosure.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of the embodiments of the disclosure and are not necessarily drawn to scale, in which:

FIG. 1 illustrates an example communication network in which embodiments of the present disclosure may be implemented;

FIG. 2 shows transmission of PDCCH schematically;

FIG. 3 shows transmission of evolved PDCCH (EPDCCH) schematically;

FIG. 4 shows an example of control signal transmission in a prior art;

FIG. 5 shows a two-level DCI according to an embodiment of the present disclosure;

FIG. 6 shows content of the second DCI of a two-level DCI according to an embodiment of the present disclosure;

FIGS. 7-8 show examples for implicit configuration information for the second DCI of a two-level DCI according to embodiments of the present disclosure;

FIG. 9 shows an example of multi user multiplexing of the second DCI of a two-level DCI according to an embodiment of the present disclosure;

FIGS. 10-11 shows an example of multiplexing the second DCI with data transmission according to embodiments of the present disclosure;

FIGS. 12, 14-16 show flowcharts of methods for transmitting a two-level control message according to embodiments of the present disclosure;

FIG. 13 shows another example of a two-level DCI according to an embodiment of the present disclosure;

FIGS. 17-20 show flowcharts of methods for receiving a two-level control message according to embodiments of the present disclosure; and

FIG. 21 illustrates a simplified block diagram of an apparatus that may be embodied as/in a network device or a terminal device.

### DETAILED DESCRIPTION

Hereinafter, the principle and spirit of the present disclosure will be described with reference to illustrative embodiments. It should be understood that all these embodiments are given merely for one skilled in the art to better understand and further practice the present disclosure, but not for limiting the scope of the present disclosure. For example, features illustrated or described as part of one embodiment may be used with another embodiment to yield still a further embodiment. In the interest of clarity, not all features of an actual implementation are described in this specification.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “wireless communication network” refers to a network following any suitable wireless communication standards, such as New Radio (NR), Long Term Evolution (LTE), LTE-Advanced (LTE-A), Wideband Code Division Multiple Access (WCDMA), High-Speed Packet Access (HSPA), and so on. The “wireless communication network” may also be referred to as a “wireless communication system.” Furthermore, communications between network devices, between a network device and a terminal device, or between terminal devices in the wireless communication network may be performed according to any suitable communication protocol, including, but not limited to, Global System for Mobile Communications (GSM), Universal Mobile Telecommunications System (UMTS), Long Term Evolution (LTE), New Radio (NR), wireless local area network (WLAN) standards, such as the IEEE 802.11 standards, and/or any other appropriate wireless communication standard either currently known or to be developed in the future.

As used herein, the term “network device” refers to a node in a wireless communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communications. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “communication device”, “terminal”, “user equipment” and “UE” may be used interchangeably.

As yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink (DL) transmission refers to a transmission from a network device to UE, and an uplink (UL) transmission refers to a transmission in an opposite direction.

FIG. 1 illustrates an example wireless communication network 100 in which embodiments of the present disclosure may be implemented. As shown, the wireless communication network 100 may include one or more network devices, for example, network device 101. The network device 101 may be in a form of a base station (BS), a Node B (NB), an evolved NB (eNB), a gNB, a virtual BS, a Base Transceiver Station (BTS), or a Base Station Subsystem (BSS), AP and the like.

In this example, network device 101 provides radio connectivity to a set of UEs 102, 103, and 104 within its coverage. It should be appreciated that in some embodiments, the network device may provide service to less or more UEs and the number of UEs shown in this example does not suggest any limitations as to the scope of the present disclosure.

In a LTE network, an eNB controls UL/DL transmission from/to UE via a control signal carried in a DCI in a PDCCH. In the present disclosure, a “control signal” may also be referred to as a “control message”, i.e., the two terms may be used interchangeably.

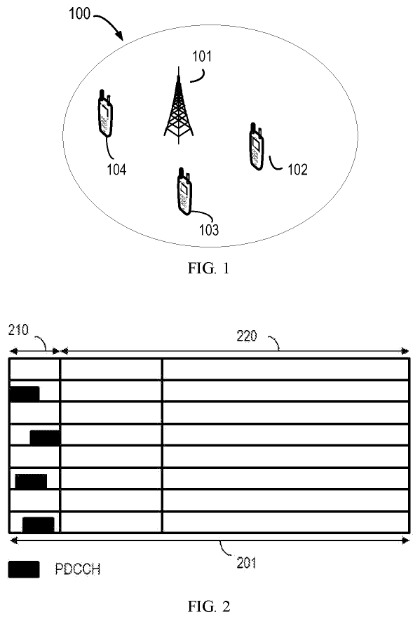

As shown schematically in FIG. 2, transmission of the PDCCH occupies a control resource region 210 including whole system bandwidth and first several OFDM symbols in a subframe 201. A physical downlink shared channel (PDSCH) carrying DL data is transmitted in a data resource region 220 in the subframe 201.

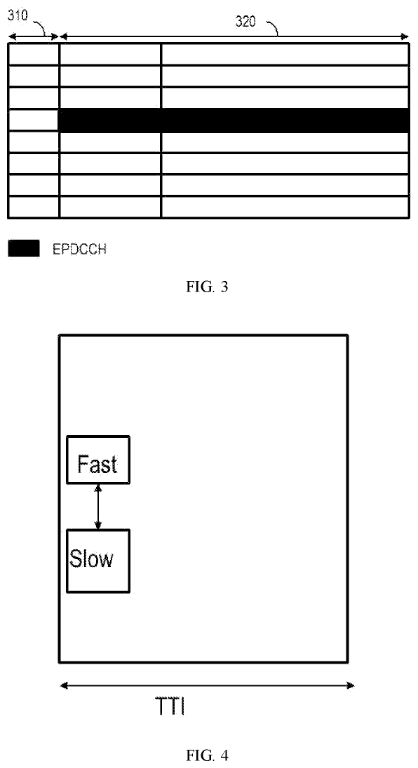

In LTE-A, an enhanced PDCCH (EPDCCH) is introduced. The EPDCCH has almost the same function as PDCCH, and provides an extend capacity for control signal transmission by transmitting the DCI in a data resource region 320, as shown in FIG. 3. Since EPDCCH occupies OFDM symbols in the data resource region following the control resource region 310, it increases latency for control signal detection compared with conventional PDCCH.

On the other hand, EPDCCH only occupies partial system bandwidth, and therefore physical resources (e.g., physical resource blocks (PRBs), subcarriers or resource elements (REs)) used for an EPDCCH transmission may or may not be continuous in frequency. In other words, the EPDCCH may be mapped to localized or distributed frequency resources in the system bandwidth for transmission. As a result, EPDCCH enables flexible frequency domain scheduling and facilitates interference coordination.

In addition, each EPDCCH is transmitted together with a demodulation reference signal (DMRS) which is used for demodulation of the EPDCCH. It enables DMRS based reception at UE side. For instance, 4 ports DMRS in total may be configured, and EPDCCH for one UE may be transmitted using 1 port for localized resource mapping, or two ports for distributed resource mapping.

At UE side, both the PDCCH and the EPDCCH have to be detected blindly. That is, no knowledge about configuration (e.g., a resource and a format) of a DCI is available to the UE before detection of the DCI completes.

To enable more flexible scheduling, a concept of two-level DCI has been proposed. In a patent application NO. WO2013/026418A1, a combination of a first-level DCI and a second-level DCI is utilized for indicating control/scheduling information for a DL data transmission. In other words, the second-level DCI may be considered as a complementary to the first-level DCI. Such a DCI structure provides more functions and flexibility for scheduling. However, both the first-level DCI and the second-level DCI are located in the control resource region (also referred to as a coreset), and need to be detected by the UE blindly. In another United States (US) patent application NO. 20160128028, a combination of a fast PDCCH and a slow PDCCH is utilized for scheduling, as shown schematically in FIG. 4. Similar to the scheme in the patent application NO. WO2013/026418A1, both the fast and slow PDCCHs locate in a control resource region and need to be detected blindly. Therefore, compared with a conventional PDCCH, current two-level DCI requires increased detection complexity.

To solve at least some of the above problems and some other potential problems, a new design/structure for two-level control signal transmission is proposed herein. The proposed design/structure enables flexible scheduling and better interference control for the control signal. It should be appreciated that the control signal may include, but is not limited to, scheduling information for UL or DL transmission.

In some embodiments, a two-level DCI, including a first DCI and a second DCI, is used for transmitting the control signal. The first DCI has a predefined size and is sent in a resource in a control resource region (e.g., coreset in a 3GPP new radio (NR) system), while the second DCI has a variable size and is sent in a resource in a data resource region, for example, via PDSCH. The variable size of the second DCI means a larger and/or more flexible payload.

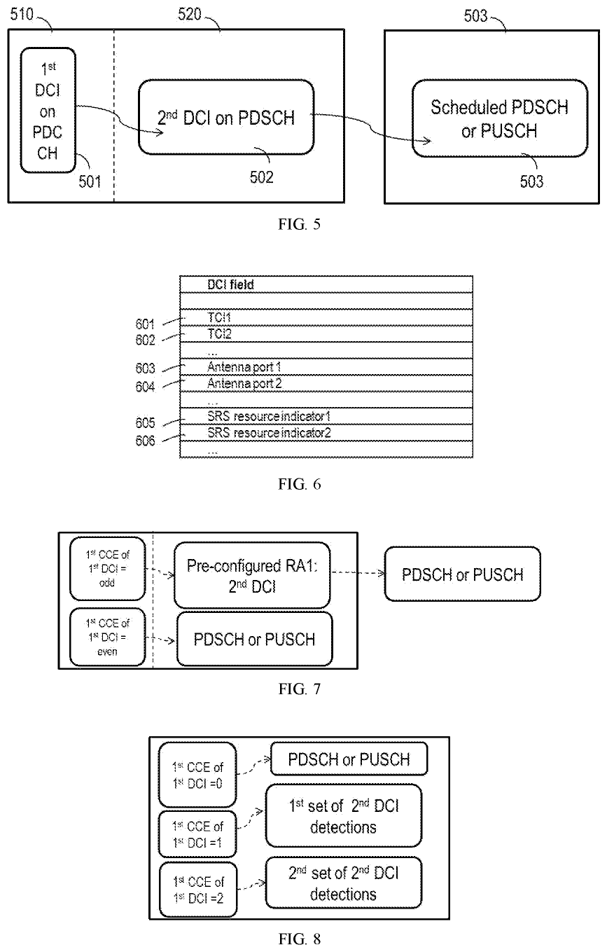

An example of the proposed two-level DCI is shown in FIG. 5. In this example, a first DCI 501 is transmitted in a control resource region 510, and a second DCI 502 is transmitted in a data resource region 520. The first DCI 501 may stay simple, compact and finite in format as a conventional design, and may include information facilitating detection of the second DCI 502. Due to the information included in the first DCI 501, detection complexity (e.g., blind detections) of the second DCI 502 may be reduced.

In addition, since the second DCI 502 is transmitted in the data resource region, a frequency resource for the transmission may be selected adaptively (for example based on channel condition or interference level), and therefore, better interference coordination may be achieved.

In the example of FIG. 5, scheduling information for a DL transmission 503 in PDSCH (or an UL transmission in physical uplink shared channel (PUSCH)) may be detected from the second DCI 502 or both the first DCI 501 and the second DCI 502. For example, at UE side, the first DCI 501 and the second DCI 502 may be detected sequentially to obtain scheduling information for the PDSCH/PUSCH transmission 503. Then the PDSCH/PUSCH may be detected/transmitted accordingly based on the scheduling information.

Note that a conventional discontinuous transmission (DTX) detection or DL assignment indicator (DAI) based mechanism similar to what is specified in a LTE technical specification TS 36.213 v10.0.0 or a NR technical specification TS 38.213 v15.2.0, may be used for detecting a miss-detection, in case one or both of the two DCIS 501 and DCI 502 are lost.

The first DCI 501 may include all or part of the information required for detection of the second DCI 502. For example rather than limitation, in some embodiments, the first DCI 501 may carry one or more of the following configuration information required for detecting the second DCI 502: presence of the second DCI 502, a frequency domain resource, a time domain resource, a frequency-time location, a modulation and coding scheme (MCS), a virtual resource block to physical resource block mapping rule, a search space, an aggregation level (AL), etc. In some embodiments, the frequency-time location indicated for the second DCI 502 may include a dedicated corset.

In some embodiments, part of the configuration information required for detecting the second DCI 502 may be semi-statically configured by higher layer, e.g., via a radio resource control (RRC) signaling, or activated by a media access control (MAC) control element (CE). That is to say, some configuration information for detecting the second DCI of a two-level DCI may not be dynamically configured via physical layer signaling (e.g., the first DCI 501), but configured in a semi-persistent way. Information that are semi-statically configured for the DCI 502 may include, for example (but is not limited to) one or more of: a frequency domain resource, a time domain resource, a frequency-time location, a modulation and coding scheme, a virtual resource block to physical resource block mapping rule, a dedicated coreset defined in NR system, a search space and an aggregation level, etc.

In some embodiments, configuration information for the DCI 502 may be indicated via a combination of a dynamic signaling and a semi-static configuration. For instance, the first DCI 501 may indicate whether the second DCI 502 will be transmitted and a search space and/or an aggregation level for the DCI 502, while resource allocation (RA) and MCS for transmitting the DCI 502 may be configured via RRC.

It should be appreciated that for the two-level DCI proposed herein, the first DCI may indicate part or all configuration information for the second DCI in an explicit or implicit manner, or a combination thereof.

For illustration rather than limitation, some examples for indicating the configuration information for the second DCI explicitly are shown in Table 1 and Table 2. In the example of Table 1, the first DCI includes one bit for indicating whether the second DCI will be transmitted. For instance, a bit with a value of “0” may indicate that no second DCI is to be expected, or in other words, the PDSCH/PUSCH will be scheduled via the first DCI directly. A bit with a value of “1” may indicate that the second DCI will be transmitted, and in this case, the second DCI or a combination of the first DCI and the second DCI will be used for scheduling a DL or UL transmission.

TABLE 1
Example 1 of explicit indication for the 2^{nd} DCI

| 1 bit | Interpretation |
|---|---|
| 0 | No 2^{nd} DCI |
| 1 | With 2^{nd} DCI |

TABLE 2
Example 2 of explicit indication for the 2^{nd} DCI

| 2 bit | Interpretation |
|---|---|
| 00 | No 2^{nd} DCI |
| 01 | 2^{nd} DCI for mode 1 |
| 10 | 2^{nd} DCI for mode 2 |
| 11 | 2^{nd} DCI for mode 3 |

In the example of Table 2, 2 bits in the first DCI are used for indicating configuration of the second DCI. For instance, a value of “00” of the two bits may indicate that the second DCI is unavailable, while other values may indicate presence of the second DCI. Furthermore, each of the values “01”, “10” and “11” may indicate a different configuration/mode for the second DCI, as shown in Table 2. The modes for the second DCI by different values of the 2 bits (e.g., “01”, “10” and “11”) may indicate different frequency and/or time resource, MCS, aggregation level, search space, size or format for the second DCI.

Just for illustration rather than limitation, the second DCI may be configured to support multiple transmit/reception points (TRPs), and may carry separate transmission control indicator (TCI) and separate DMRS group for each TRP. The TCI indicates a reception beam for a TRP as defined in NR system. In such a case, each of the values “01”, “10” and “11” of the 2 bits included in the first DCI may indicate a different number (e.g., 2, 3, 4) of TRPs supported by the second DCI, and correspondingly a different second DCI size.

As another example, the second DCI may be configured to support an uplink (e.g., PUSCH) transmission with frequency selective precoding where a number of precoding groups is defined and in a precoding group the targeted frequency bands share the same precoder, and some different values of the 1, 2 or more bits in the first DCI may indicate different number (e.g., 2, 3, and 4) of precoding groups supported by the second DCI, and correspondingly a different size of the second DCI.

Alternatively, in some embodiments, the second DCI may be configured to include a plurality of MCS and/or transport blocks (TBs) for a PDSCH transmission. In such a case, different values of the 1, 2 or more bits included in the first DCI may indicate different number (e.g., 2, 3, and 4) of MCS/TBs supported by the second DCI, and correspondingly a different size for the second DCI.

Alternatively or in addition, in some embodiments, a mode of the second DCI indicated by different values of bits included in the first DCI may specify one or both of: a search space restriction and an aggregation level restriction for reducing blind detection of the second DCI. For example, each of the values “01”, “10” and “11” of 2 bits in the first DCI may indicate different sets for blind detecting of the second DCI. Correspondingly each value may indicate a different number of time-frequency positions and complexity for the blind detection.

In an example shown in FIG. 6, the second DCI may accommodate 2 (or more) TCIs 601 and 602, 2 (or more) antenna ports configurations 603 and 604, and/or 2 (or more) SRS resource indicators 605 and 606. Then one or more bits included in the first DCI may indicate the exact number of TCIs, antenna ports configurations, and/or SRS configurations included in the second DCI.

In some embodiments, the first DCI may alternatively or additionally indicate some configuration information for the second DCI implicitly. For illustration rather than limitation, some information for detecting the second DCI may be indicated implicitly via an index of a Control channel element (CCE) for the first DCI. FIGS. 7 and 8 show examples for the implicit indication.

In the example of FIG. 7, if the index of the first CCE for the first DCI is odd, it indicates that there is a second DCI following the first DCI; otherwise (i.e., when the index of the first CCE is even), the second DCI is unavailable, and in such a case, the first DCI schedules DL transmission (e.g., PDSCH) or UL transmission (e.g., PUSCH) directly.

In another example shown in FIG. 8, the index of the first CCE for the first DCI is used for indicating more information compared with the example of FIG. 7. For instance, if the index of the first CCE mod 3=0, it may indicate that the second DCI is unavailable, i.e., the first DCI schedules a DL/UL transmission directly. Other values of modulo result indicate existence of the second DCI. In addition, if the index of the first CCE mod 3=1, it may indicate a first set of blind detections for the second DCI, and if the index of the first CCE mod 3=2, it may indicate a second set of blind detections for the second DCI. Each set of blind detection has one or more corresponding search space(s) and aggregation level(s) for blind detection of the second DCI. With such implicit indication, first DCI may be used to flexibly reduce the blind detections of the second DCI based on channel conditions.

It should be appreciated that FIGS. 7 and 8 are provided just for illustration purpose, and embodiments of the present disclosure are not limited to the specific way for indicating the configuration information for the second DCI. For example, in some embodiments, a result of the index of the first CCE modulo N may be utilized to indicate the information for the second DCI, where N may be an integer larger than 2.

Note that, the configuration information for the second DCI may not necessarily be indicated (only) via the index of the first CCE of the first DCI. In some embodiments, alternatively or in addition, a corset index, an aggregation level and/or a MCS for the first DCI may be used to indicate configuration information for the second DCI implicitly. For instance, if the first DCI is detected in a predetermined coreset, the terminal device may determine that an index of the first CCE for the first DCI is used for indicating configuration information for the second DCI implicitly, and in such a case, an index of the first CCE of the second DCI may be used for indicating a PUCCH resource in responding to the scheduled PDSCH. On the other hand, if the first DCI is detected in a corset other than the predetermined coreset, the index of the first CCE for the first DCI may indicate a corresponding PUCCH resource instead, similar to a mechanism as specified in LTE or NR.

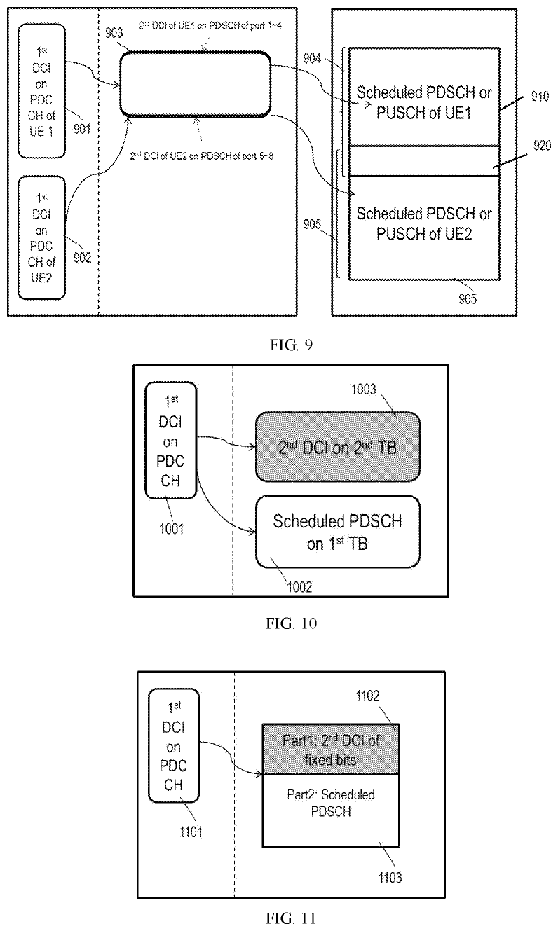

In some embodiments, the two-level DCI proposed in the present disclosure may support a MU-MIMO transmission of the second DCI to increase resource efficiency. For illustration rather than limitation, an example of the MU-MIMO transmission of the second DCI for two terminal devices is shown in FIG. 9. In this example, there are separate first DCIs for UE1 and UE 2 respectively. The first DCI 901 for UE 1 may schedule a second DCI to be transmitted via antenna ports (or DMRS ports) 1 to 4, while the first DCI 902 for UE 2 may indicate a second DCI to be transmitted via antenna ports (or DMRS ports) 5 to 8. In this way, the second DCI for different UEs occupy same frequency-time resource 903 and are identified by antenna ports. As a result, resource allocation required for transmitting a two-level DCI is reduced. In some embodiments, the first DCI of the two-level DCI for supporting the MU-MIMO transmission of the second DCI may have a DCI format 1_1 as specified in NR system.

In addition, in the example shown in FIG. 9, the second DCI for UE 1 schedules a PDSCH/PUSCH transmission in a resource 904 and the second DCI for UE 2 schedules a PDSCH/PUSCH transmission in a resource 905. Note that, the resource 904 and the resource 905 may (or may not) overlap or partially overlap in resource allocation. In some embodiments, the scheduled PDSCH/PUSCH may be assigned different MCS for non-overlapped resource and overlapped resource, respectively. For example, the PDSCH/PUSCH for UE 1 in the overlapped resource 910 may be assigned a MCS 1A (e.g., QPSK), while the PDSCH/PUSCH for UE 1 in the non-overlapped resource 920 may be assigned a MCS 1 (e.g., 16QAM). Such a scheme provides flexibility for link adaptive, and is robust to interference.

Alternatively, in some embodiments, the second DCI scheduled by the first DCI of the proposed two-level DCI may be multiplexed with a DL data transmission (e.g., PDSCH) scheduled by the same first DCI, as shown in FIGS. 10 and 11. In other words, the second DCI may be scheduled by the first DCI, together with a DL data transmission (e.g., PDSCH). The second DCI may include a scheduling grant for a further PDSCH/PUSCH transmission (not shown).

In the example shown in FIG. 10, the first DCI 1001 supports scheduling of two transport blocks (TBs), where a first TB is used for PDSCH 1002, while a second TB may be used for the second DCI 1003 or a PDSCH, or not transmitted at all. In such a case, the first DCI 1001 may further indicate a configuration of the second TB implicitly or explicitly, i.e., whether the second TB is transmitted, and/or whether it carries the second DCI or normal DL data (e.g., PDSCH). For example rather than limitation, if the first DCI is transmitted in a predetermined corset, the terminal device may determine that the second TB scheduled by the first DCI carries the second DCI; otherwise, the terminal device may determine that normal data is included in the second TB. Alternatively, the first DCI may include an additional bit to indicate the type of the second TB. For example, a “0” value of the additional bit may indicate that normal data is in the second TB (or the second TB is not transmitted at all), while a “1” value of the additional bit may indicate that the second DCI is on the second TB.

In another example of DCI and data multiplexing shown in FIG. 11, the first DCI 1101 supports scheduling of a resource allocation (RA) 1110 with two parts, a first part of which is for transmission of DL data (e.g., PDSCH) 1103, while a second part of which is for transmission of the second DCI 1102 (or left unused). Similar to that described with reference to FIG. 10, in the example of FIG. 11, the first DCI may indicate implicitly (e.g., via a corset for the first DCI) or explicitly (e.g., via a bit in the first DCI) content transmitted in the second part of the resource allocation, i.e., whether normal DL data, the second DCI, or nothing is transmitted in the second part of the RA. Note that the second DCI 1102 transmitted in the second part of the RA 1110 may include a scheduling grant for a further PDSCH/PUSCH transmission (not shown).

Embodiments of the present disclosure provide more flexibility in scheduling and reduced complexity for detection of the second DCI compared with conventional solutions.

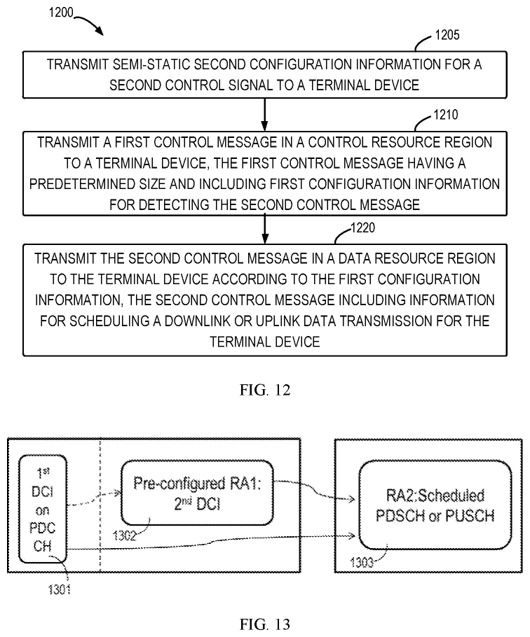

To facilitate better understanding of the present disclosure, some further embodiments will be provided below with reference to FIGS. 12-20.

FIG. 12 shows a flow chart of an example method 1200 which may be performed by a network device, for example, the network device 101 in FIG. 1. Just for illustration purpose, the method 1200 will be described below with reference to the network device 101 and the communication network 100 illustrated in FIG. 1; however, it should be appreciated that embodiments of the present disclosure are not limited thereto.

As shown in FIG. 12, at block 1210, the network device 101 transmits a first control message (e.g., the first DCI 501 in FIG. 5) in a control resource region (e.g., the control resource region 510) shown in FIG. 5 to a terminal device, for example UE 102 in FIG. 1. The first control message has a predetermined size and includes first configuration information for detecting a second control message. In some embodiments, the first control message and the second control message forms a two-level control message, which may be used for scheduling a DL or UL transmission (e.g., PDSCH or PUSCH). In some embodiments, the first control message and the second control message may be in a form of a DCI, however, embodiments of the present disclosure are not limited thereto.

In some embodiments, the first configuration information included in the first control message for detecting the second control message may indicate one or more of the following: existence of the second control message as shown in Table 1 and Table 2, a search space for the second control message, an aggregation level for the second control message, a mode of the second control message as shown in Table 2, and a set of blind detection to be performed for the second control message. Therefore, the first configuration information helps to reduce detection complexity of the second control message at the UE side.

As described with reference to Table 2, the mode of the second control message indicated by the first configuration information may indicate the number of TRPs for which separate scheduling information is included in second control message. For example, mode 1 of the second control message may indicate that scheduling information for 2 TRPs are included in the second control message, while mode 1 of the second control message may indicate that scheduling information for 3 TRPs are included in the second control message.

Alternatively or in addition, the mode of the second control message may indicate the number of uplink precoding groups, TBs, or MCs, or a combination thereof supported/indicated by the second control message.

In some embodiments, the mode of the second control message may indicate a set of blind detection to be performed for the second control message. For example, mode 1 may indicate that a first set of blind detection is to be performed for detecting the second control message, while modes 2 and 3 may indicate that a second set and a third set of blind detection are to be performed respectively. Alternatively or in addition, in some embodiments, the mode of the second control message may indicate a search space or an aggregation level (or a set of aggregation levels) for detecting the second control message.

Note that the first control information included in the first control message may be carried by the first control message in an explicit or implicit way. Tables 1 and 2 above show examples for indicating the first control information explicitly, where the first control message (e.g., a first DCI) includes one or more bits for indicating the first configuration information.

Alternatively, FIGS. 7 and 8 illustrate schematically schemes for indicating the first configuration information for the second control message (e.g., a second DCI) implicitly, i.e., without using additional bits in the first control message. For example, the network device 101 may transmit the first control message on a plurality of control channel elements (CCEs) in the control resource region, and an index of the first CCE of the plurality of CCEs may be used to indicate the first configuration information for detecting the second control message implicitly. In the example shown in FIG. 7, an odd index of the first CCE indicates that the second control message is scheduled by the first control message, and an even index of the first CCE indicates that a downlink or uplink data transmission is scheduled by the first control message. It should be appreciated that, in another example embodiment, an even index of the first CCE may indicate that the second control message is scheduled by the first control message, and an odd index of the first CCE may indicate that a downlink or uplink data transmission is scheduled by the first control message. This is equivalent to use a result of the index of the first CCE modulo 2 to indicate the first configuration information.

In some embodiments, a result of the index of the first CCE modulo N may be used to indicate the first configuration information for detecting the second control message, where N may be an integer larger than 2. In the example shown in FIG. 8, the result of the index of the first CCE modulo 3 is used to indicate one or both of: existence of the second control message and a configuration (e.g., a set of blind detection) for the second control message.

Note that embodiments of the present disclosure are not limited to indicate the first configuration information for the second message via the index of the first CCE. In other words, in some embodiments, other information (e.g., location, aggregation level, MCS) of the first control message may be used to indicate the first configuration information implicitly. As an example, if the first control message is transmitted by the network device 101 in a predetermined control resource set (e.g., a dedicated corset), it may imply that the second control message should be detected; otherwise, it may imply that the second control message does not exist. As another example, only when the first control message is transmitted by the network device 101 in a predetermined control resource set (e.g., a dedicated corset), the index of the first CCE of the first control message indicates the first configuration information for detecting the second control message implicitly.

It should be appreciated that the first configuration information carried by the first control message explicitly or implicitly may not include all information necessary for detecting the second control message. That is, the first configuration information may only reduce blind detection of the second control message, rather than avoiding blind detection of the second control message.

In some embodiments, besides the first configuration information included in the first control message, the network device 101 may further transmit second configuration information for the second control message to the UE 102, as shown in block 1205 of FIG. 12. The second configuration information may be semi-static, while the first configuration information may be dynamic. That is, the second configuration information may be transmitted by the network device 101 via a higher layer signaling, e.g., RRC signaling, or MAC CE. For illustration rather than limitation, the semi-static second configuration information for the second control message may comprise at least one of: a frequency and/or time location, a modulation and coding scheme, MCS, and a virtual resource (e.g., a virtual resource block, VRB) to physical resource (e.g., a physical resource block, PRB) mapping.

As shown in FIG. 12, at block 1220, the network device 101 transmits the second control message (e.g., the second DCI 502 in FIG. 5) in a data resource region (e.g., the data resource region 520 in FIG. 5) to the UE 102 according to the first configuration information. The second control message includes information for scheduling a downlink or uplink data transmission (e.g., the PDSCH/PUSCH transmission 503 in FIG. 5) for the UE 102.

With embodiments of method 1200, blind detection of the second control message is reduced. Furthermore, in some embodiments, the first control message stays as simple, compact and finite as conventional design, while the second control message provides better interference coordination, and flexible/larger payload.

In some further embodiments, at block 1220, the second control message may be transmitted by the network device 101 on a plurality of resource units (e.g., CCEs) in the data resource region, and an index of the first resource unit (e.g., first CCE) of the plurality of resource units may indicate a resource for a corresponding uplink feedback (e.g., PUCCH).

Though the second control message includes information (e.g., MCS) for scheduling the downlink or uplink data transmission (e.g., PDSCH/PUSCH) for the UE 102, it should be appreciated that, in some embodiments, the downlink or uplink data transmission may be detected at the UE side based on both the first control message and the second control message. For example, the first control message transmitted by the network device 101 may include resource allocation information for the downlink or uplink data transmission for UE 102, as shown in FIG. 13. In the example of FIG. 13, the first control message 1301 includes resource allocation information (RA2) for PDSCH/PUSCH transmission 1303, and the second control message 1302 includes further scheduling information (e.g., MCS, precoding information) for the PDSCH/PUSCH transmission 1303. Resource allocation information (RA1) for the second control message 1303 may be preconfigured semi-statically via higher layer signaling. Optionally, in this example, the first control message 1301 may further include configuration information for detecting the second control message 1302.

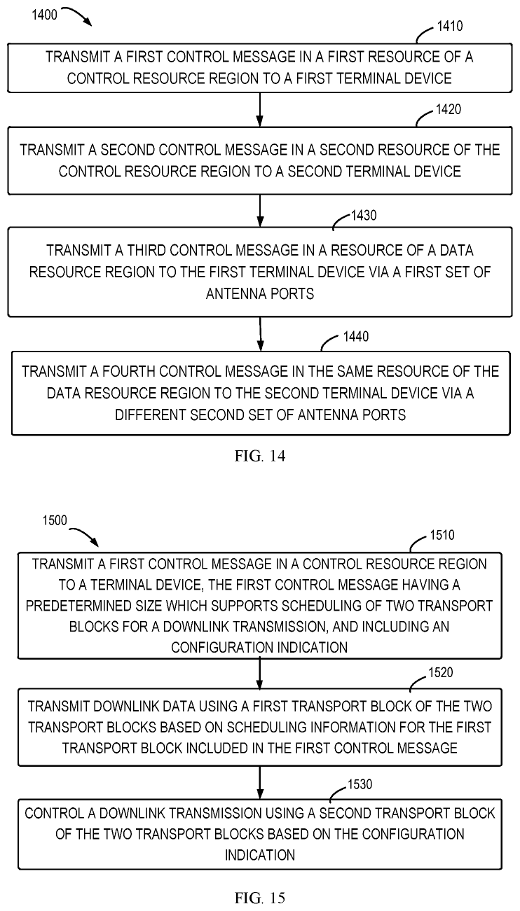

In some embodiments, to improve resource efficiency, the second control message of the proposed two-level control message may be multiplexed with other transmissions. As an example, FIG. 14 shows a flow chart of a method 1400 for MU-MIMO transmission of the second control message.

The method 1400 may be performed by a network device, for example, the network device 101 in FIG. 1. Just for illustration purpose, the method 1400 will be described below with reference to the network device 101 and the communication network 100 illustrated in FIG. 1; however, it should be appreciated that embodiments of the present disclosure are not limited thereto.

As shown in FIG. 14, at block 1410, network device 101 transmits a first control message (e.g., the DCI 901 in FIG. 9) in a first resource of a control resource region to a first terminal device (e.g., UE 102 in FIG. 1); at block 1420, network device 101 transmits a second control message (e.g., the DCI 902 in FIG. 9) in a second resource of the control resource region to a second terminal device (e.g., UE 103 in FIG. 1).

The first control message and the second control message each have a predetermined size and include information for detecting a third control message for UE 102 and a fourth control message for UE 103 respectively.

Note that, in some embodiments, the information for detecting the third control message for UE 102 and the fourth control message for UE 103 may be same as the first configuration information described above with reference to FIG. 12, and therefore related descriptions also apply here, and details will not be repeated.

In addition, the information for detecting the third/fourth control message may be indicated in the first/second control message explicitly or implicitly, as described above with reference to FIGS. 7, 8, 12 and Tables 1 and 2.

At block 1430, network device 101 transmits the third control message in a resource (e.g., resource 903 in FIG. 9) of a data resource region to the UE 102 via a first set of antenna ports (e.g., antenna ports 1 to 4); and at block 1440, the network device 101 transmits the fourth control message in the same resource (e.g., resource 903 in FIG. 9) of the data resource region to the UE 103 via a different second set of antenna ports (e.g., antenna ports 5 to 8). The third control message may be the second DCI of a two-level DCI for UE 102, and the fourth control message may be the second DCI of a two-level DCI for UE 103. That is, the third control message and the fourth control message may include information for scheduling a data transmission for UE 102 and UE 103 respectively.

With method 1400, the second DCI for different UEs are multiplexed via special divisional multiplexing (SDM) by using different antenna ports. Therefore time-frequency resource required for transmitting the second DCI for multiple UEs is reduced.

In some embodiments, the third control message indicates a first resource allocation (e.g., resource 904 in FIG. 9) for a data transmission for the UE 102, and the fourth control message indicates a second resource allocation (e.g., resource 905 in FIG. 9) for a data transmission for UE 103, and the first resource allocation may partially overlaps with the second resource allocation, as shown in the example of FIG. 9. In this case, the interference in overlapped resource (e.g., resource 910 in FIG. 9) and non-overlapped resource (e.g., resource 920 in FIG. 9) may be different.

In some embodiments, to enable more flexible scheduling for data transmission and/or to provide robust link adaptation, the third control message transmitted by the network device 101 with method 1400 may indicate a first MCS for the data transmission for the UE 102 in a first part (e.g., resource 910 in FIG. 9) of the first resource allocation overlapping with the second resource allocation, and a second MCS for the data transmission for UE 102 in second part (e.g., resource 920 in FIG. 9) of the first resource allocation not overlapping with the second resource allocation. Likewise, the fourth control message transmitted by the network device 101 for UE 103 may also indicate a first MCS and a second MCS for overlapped part and non-overlapped parts of the resource allocation for data transmission.

In some embodiments of method 1400, the number of MCS included in the third/fourth control message (which may be the second DCI of a two-level DCI for a UE) may be indicated explicitly or implicitly in the first/second control message (which may be the first DCI of a two-level DCI for the UE), as described with reference to Table 2 and FIGS. 8 and 12.

FIG. 15 shows a flow chart of a method 1500 for multiplexing the second control message of a two-level control message with a data transmission. The method 1500 may be performed by a network device, for example, the network device 101 in FIG. 1. Just for illustration purpose, the method 1500 will be described below with reference to the network device 101 and the communication network 100 illustrated in FIG. 1; however, it should be appreciated that embodiments of the present disclosure are not limited thereto.

As shown in FIG. 15, at block 1510, network device 101 transmits a first control message (e.g., the first DCI 1001 in FIG. 10) in a control resource region to a terminal device, e.g., UE 102 in FIG. 1. The first control message has a predetermined size that supports scheduling of two transport blocks (TBs) for a downlink transmission (e.g., PDSCH), and includes a configuration indication, for example, an indication bit.

At block 1520, network device 101 transmits downlink data (e.g., PDSCH 1002 in FIG. 10) using a first TB of the two TBs based on scheduling information for the first TB included in the first control message.

At block 1530, network device 10 controls a downlink transmission using a second TB of the two TBs based on the configuration indication. The configuration indication (e.g., an indication bit) may indicate content to be carried in the second TB, or existence of the second TB.

For example rather than limitation, at block 1530, if the indication bit has a first value (e.g., 1), the network device 101 transmits a second control message (e.g., the second DCI 1003 in FIG. 10) using the second TB. On the other hand, if the indication bit has a second value (e.g., 0), the network device 101 may transmit data using the second TB, or, do not transmit the second TB at all (i.e., prevent transmitting using the second transport block).

In some embodiments, the indication bit may be omitted, and an implicit configuration indication may be used instead. For example, if the first DCI is transmitted in a dedicated corset, the second control message is transmitted in the second TB; otherwise, data is transmitted using the second TB, or the second TB is not transmitted.

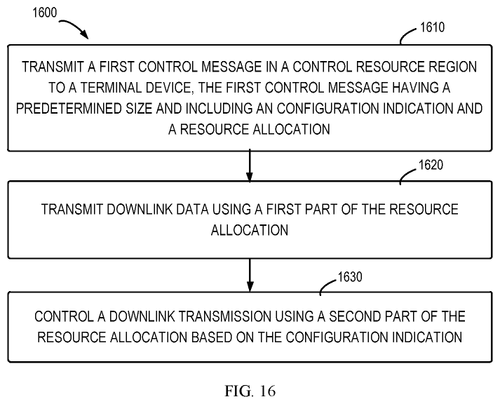

FIG. 16 shows a flow chart of another method 1600 for multiplexing the second control message of a two-level control message with a data transmission. The method 1600 may be performed by a network device, for example, the network device 101 in FIG. 1. Just for illustration purpose, the method 1600 will be described below with reference to the network device 101 and the communication network 100 illustrated in FIG. 1; however, it should be appreciated that embodiments of the present disclosure are not limited thereto.

As shown in FIG. 16, at block 1610, network device 101 transmits a first control message (e.g., the first DCI 1101 in FIG. 11) in a control resource region to a terminal device, e.g., UE 102 in FIG. 1). The first control message has a predetermined size and includes a configuration indication, for example an indication bit, and a resource allocation (RA).

The network device 101 transmits downlink data (e.g., PDSCH 1003 in FIG. 11) using a first part of the resource allocation (e.g., resource 1110 in FIG. 11) at block 1620; and controls a downlink transmission using a second part of the resource allocation based on the configuration indication at block 1630. The configuration indication may indicate content to be carried in the second part of the resource, or whether to use the second part of the resource for transmission.

For example rather than limitation, at block 1630, if the indication bit has a first value (e.g., 1), the network device 101 transmits a second control message (e.g., the second DCI 1102 in FIG. 11) using the second part of the RA. On the other hand, if the indication bit has a second value (e.g., 0), the network device 101 may transmit data using the second part of the RA, or, leave the second part of RA unused (i.e., prevent transmitting using the second part of the RA) for this UE 102.

Note that in some embodiments, the indication bit may be omitted, and an implicit configuration indication may be used instead. For example, if the first DCI is transmitted in a dedicated corset, the second control message is transmitted in the second part of the RA; otherwise, data is transmitted using the second part, or the second part of RA is left unused for the UE 102.

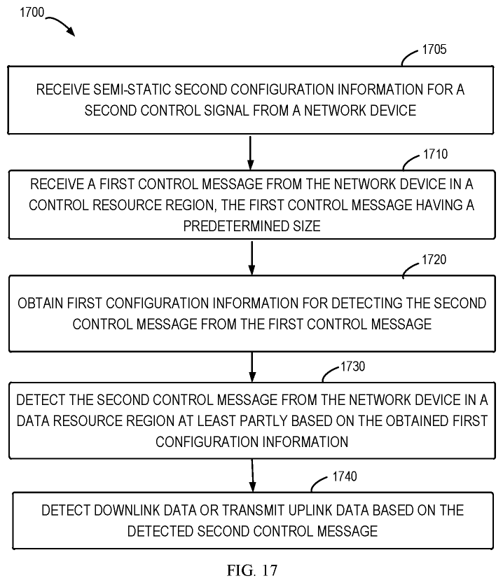

FIGS. 17-20 show some example methods for signal detection at a terminal device side. These methods may be used for by the terminal device (e.g., UE 102, 103 or 104) for detecting a two-level control message as proposed in the present disclosure. Just for illustration purpose, the methods 1700-2000 will be described below with reference to the UE 102 and the communication network 100 illustrated in FIG. 1; however, it should be appreciated that embodiments of the present disclosure are not limited thereto.

In the method 1700 shown in FIG. 7, at block 1710, UE 102 receives a first control message (e.g., the first DCI 501 of a two-level DCI in FIG. 5) from a network device (e.g., network device 101 in FIG. 1) in a control resource region (e.g., control resource region 510 in FIG. 5). The first control message has a predetermined size.

At block 1720, UE 102 obtains first configuration information for detecting a second control message (e.g., the second DCI 502 in FIG. 5) from the first control message. In some embodiments, the first configuration information may be same as that described with reference to method 1200 and FIG. 12, and therefore related descriptions also apply here and details will not be repeated. The first configuration information reduces blind detections for the second control message.

In some embodiments, the first configuration information may be carried in the first control message explicitly as one or more bits. In such embodiments, at block 1720, UE 102 obtains the first configuration information based on the one or more bits included in the first control message. Examples for the one or more bits and their meanings may be found in Table 1 and Table 2. However, it should be appreciated that embodiments are not limited thereto.

Alternatively or in addition, part or all of the first configuration information may be carried in in the first control message implicitly. For example, at block 1710, the UE 102 may receive the first control message on a plurality of CCEs in the control resource region, and then at block 1720, UE 102 may obtain the first configuration information based on an index of the first CCE of the plurality of CCEs. That is, the first CCE of the first control message indicate the first configuration information for detecting the second control message implicitly, as shown in the examples of FIGS. 7 and 8. In some embodiments, if the index of the first CCE is odd (or even), the UE 102 may determine that the second control message is scheduled by the first control message; and if the index of the first CCE is even (or odd), UE 102 may determine that a downlink or uplink data transmission (e.g., PDSCH or PUSCH) is scheduled by the first control message directly.

In another embodiment, the UE 102 may obtain the first configuration information based on a result of the index of the first CCE modulo N, wherein N is a predetermined positive integer larger than 2. For example, the UE 102 may obtain information on existence of the second control message, and/or a configuration for the second control message based on the modulo result.

In some embodiments, the UE 102 may obtain the first configuration information based on the index of the first CCE of the plurality of CCEs only when it receives the first control message in a predetermined control resource set at block 1710.

At block 1730, UE 102 detects the second control message (e.g., the second DCI 502 in FIG. 5) from the network device 101 in a data resource region (e.g., the data resource region 520 in FIG. 2) at least partly based on the obtained first configuration information.

In some embodiments, some further information for detecting the second control message may be received by the UE via another message, for example a higher layer signaling, at block 1705 of FIG. 17. The further information may be referred to as second configuration information for the second control message. In such a case, at block 1730, UE 102 may detect the second control message further based on the received second configuration information. The second configuration information may be semi-static, and may indicate at least one of: a frequency and/or time location, a modulation and coding scheme, MCS, and a virtual resource to physical resource mapping for the second control message.

The second control message includes scheduling information for DL or UL data transmission (e.g., PDSCH/PUSCH 503 in FIG. 5). Therefore, at block 1740, UE 102 detects the downlink data or transmits uplink data based on the detected second control message. In some embodiments, the first control message received at block 1710 indicates a resource allocation for the DL or UL data transmission, and in such embodiments, at block 1740, UE 102 detects the DL data or transmits the uplink data in a resource allocate by the first control message.

In some embodiments, at block 1730, UE 102 may detect the second control message in a plurality of resource units (e.g., CCEs) in the data resource region, and UE 102 may determine a resource for a corresponding uplink feedback based on an index of the first resource unit of the plurality of resource units for the second control message.

The two-level control message detection method described with reference to FIG. 17 requires reduced detection complexity at the UE side compared with a conventional solution.

In some embodiments, the second control message received by UE 102 may be transmitted by the network device 101 in a MU-MIMO manner, as described with reference to method 1400. In such a case, at the UE side, the second control message may be received by the UE 102 from a set of antenna ports indicted by the first control message.

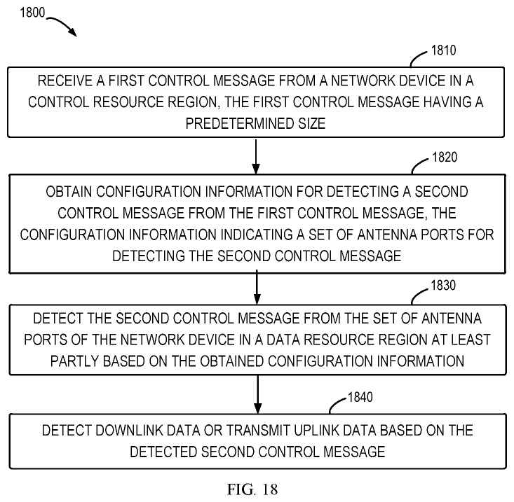

In an example method 1800 shown in FIG. 18, at block 1810, UE 102 receives a first control message (e.g., the first DCI 910 in FIG. 9) from the network device 101 in a control resource region. The first control message has a predetermined size.

At block 1820, UE 102 obtains, from the first control message, configuration information for detecting a second control message (e.g., the second DCI 903 in FIG. 9). The configuration information indicates a set of antenna ports (e.g., antenna ports 1 to 4) for detecting the second control message.

At block 1830, UE 102 detects the second control message from the set of antenna ports of the network device 101 in a data resource region, at least partly based on the obtained configuration information.

At block 1840, UE detects downlink data or transmits uplink data based on the detected second control message.

Note that in some embodiments, features of the first control message and the second message described above with reference to FIGS. 5-17 may also apply here, and therefore details will not be repeated here.

The second control message or both the first and the second control message include scheduling information for a DL or UL transmission (e.g., PDSCH/PUSCH in resource 904 in FIG. 9). In some embodiments, the resource allocated for the DL/UL transmission may overlap with a transmission for/of another UE (e.g., UE 103 in FIG. 1). In such a case, the configuration information obtained from the second control message by UE 102 at block 1820 may include a MCS for a first resource, and a second MCS for a second resource. Accordingly, at block 1840, UE 102 detects the downlink data/transmits the uplink data based on the first MCS in the first resource, based on the second MCS in the second resource. This embodiment provides more flexibility for link adaptation.

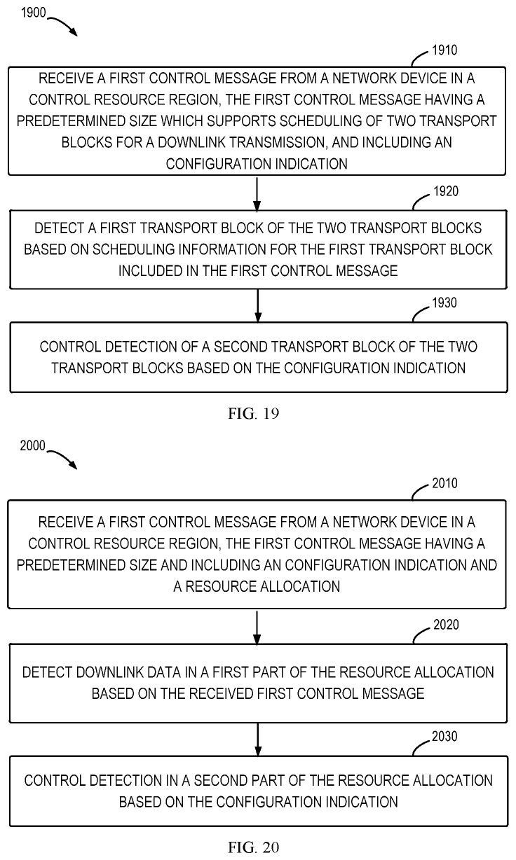

As described with reference to FIGS. 15-16, the second control message may be multiplexed with a data transmission. An example method 1900 which may be used for detecting such a two-level control message is shown in FIG. 19.

In the example of FIG. 19, at block 1910, UE 102 receives a first control message (e.g., the first DCI 1001 in FIG. 10) from network device 101 in a control resource region. The first control message has a predetermined size which supports scheduling of two TBs for a downlink transmission, and includes a configuration indication, for example an indication bit. The indication bit indicates content/existence of a second TB of the two TBs.

At block 1920, UE 102 detects a first TB of the two TBs based on scheduling information for the first TB included in the first control message. At block 1930, UE 102 controls detection of the second TB of the two TBs based on the configuration indication, e.g., the indication bit.

For example rather than limitation, if the indication bit has a first value (e.g., 1), at block 1930, UE 102 may detect the second control message from the second TB. On the other hand, if the indication bit has a second value (e.g., 0), at block 1930, UE 102 may detect data from the second TB or prevent detecting the second TB.

Alternatively, in some embodiments, the first control message received at block 1910 does not include the indication bit, and instead, it provides the configuration indication for the content/existence of a second TB of the two TBs implicitly, e.g., via a location of the first control message. In such a case, at block 1930, UE 102 controls detection of the second TB of the two TBs based on the implicit configuration indication.

Another example method 2000 which may be used for detecting a two-level control message is shown in FIG. 20. In the example of FIG. 20, at block 2010, UE 102 receives a first control message (e.g., the first DCI 1101 in FIG. 11) from network device 101 in a control resource region. The first control message has a predetermined size and includes a configuration indication, for example an indication bit, and a RA.

At block 2020, UE 102 detects DL data in a first part of the RA based on the received first control message. At block 2030, UE 102 controls detection in a second part of the RA based on the configuration indication, e.g., the indication bit.

In some embodiments, if the indication bit has a first value (e.g., 1), at block 2030, UE 102 may detect the second control message in the second part of the RA. On the other hand, if the indication bit has a second value (e.g., 0), at block 1930, UE 102 may detect data in the second part of the RA or prevent detecting in the second part of the RA.

Likewise, in some embodiments, the first control message received at block 2010 does not include the indication bit, and instead, it provides the configuration indication for the content/existence of a second TB of the two TBs implicitly, e.g., via a location of the first control message. In such a case, at block 2030, UE 102 controls detection of the second part of the RA based on the implicit indication.

The second control message which may be transmitted in the second TB in FIG. 10 or the second part of the RA in FIG. 11 may include scheduling information for a further PDSCH/PUSCH transmission of the UE 102.

The methods described with reference to FIGS. 18-20 further improve resource efficiency.

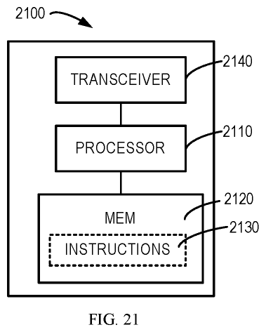

FIG. 21 illustrates a simplified block diagram of an apparatus 2100 that may be embodied in/as a network device (e.g., the network device 101 in FIG. 1) or a terminal device (e.g., UE 102, 103 or 104 in FIG. 1). The apparatus may be used for signal detection in a wireless communication system. The signal may include a two-level control message.

As shown by the example of FIG. 21, apparatus 2100 comprises a processor 2110 which controls operations and functions of apparatus 2100. For example, in some embodiments, the processor 2110 may implement various operations by means of instructions 2130 stored in a memory 2120 coupled thereto. The memory 2120 may be any suitable type adapted to local technical environment and may be implemented using any suitable data storage technology, such as semiconductor based memory terminal devices, magnetic memory terminal devices and systems, optical memory terminal devices and systems, fixed memory and removable memory, as non-limiting examples. Though only one memory unit is shown in FIG. 21, a plurality of physically different memory units may exist in apparatus 2100.

The processor 2110 may be any proper type adapted to local technical environment, and may include one or more of general purpose computers, special purpose computers, microprocessors, digital signal processors DSPs and processors based on multicore processor architecture, as non-limiting examples. The apparatus 2100 may also comprise a plurality of processors 2110.

The processors 2110 may also be coupled with a transceiver 2140 which enables reception and transmission of information. For example, the processor 2110 and the memory 2120 can operate in cooperation to implement any of the methods 1200-1600 described with reference to FIGS. 12-16, or any of the methods 1700-2000 described with reference to FIGS. 17-20. It shall be appreciated that all the features described above with reference to FIGS. 5-20 also apply to apparatus 2100, and therefore will not be detailed here.

Various embodiments of the present disclosure may be implemented by a computer program or a computer program product executable by one or more of the processors (for example processor 2110 in FIG. 21), software, firmware, hardware or in a combination thereof.

Although some of the above description is made in the context of a communication network shown in FIG. 1, it should not be construed as limiting the spirit and scope of the present disclosure. The principle and concept of the present disclosure may be more generally applicable to other scenarios.

In addition, the present disclosure may also provide a carrier containing the computer program as mentioned above (e.g., computer instructions/grogram 2130 in FIG. 21). The carrier includes a computer readable storage medium and a transmission medium. The computer readable storage medium may include, for example, an optical compact disk or an electronic memory device like a RAM (random access memory), a ROM (read only memory), Flash memory, magnetic tape, CD-ROM, DVD, Blue-ray disc and the like. The transmission medium may include, for example, electrical, optical, radio, acoustical or other form of propagated signals, such as carrier waves, infrared signals, and the like.

The techniques described herein may be implemented by various means so that an apparatus implementing one or more functions of a corresponding apparatus described with an embodiment comprises not only prior art means, but also means for implementing the one or more functions of the corresponding apparatus and it may comprise separate means for each separate function, or means that may be configured to perform two or more functions. For example, these techniques may be implemented in hardware (e.g., circuit or a processor), firmware, software, or combinations thereof. For a firmware or software, implementation may be made through modules (e.g., procedures, functions, and so on) that perform the functions described herein.

Some example embodiments herein have been described above with reference to block diagrams and flowchart illustrations of methods and apparatuses. It will be appreciated that each block of the block diagrams and flowchart illustrations, and combinations of blocks in the block diagrams and flowchart illustrations, respectively, may be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments may also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept may be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method in a wireless communication system, comprising:
transmitting a first control message in a control resource region to a terminal device, the first control message having a predetermined size and including first configuration information for detecting a second control message; and
transmitting the second control message in a data resource region to the terminal device according to the first configuration information, the second control message including information for scheduling a downlink or uplink data transmission for the terminal device.

2. The method of claim 1, wherein the first configuration information includes at least one of:
existence of the second control message,
a search space for the second control message,
an aggregation level for the second control message,
a mode of the second control message, and
a set of blind detection to be performed for the second control message.

3. The method of claim 2, wherein the mode of the second control message indicates at least one of:
the number of transmit/reception points, TRPs, for which separate scheduling information is included in second control message,
the number of uplink precoding groups supported by the second control message,
the number of transport blocks scheduled by the second control message,
the number of modulation and coding schemes indicated by the second control message,
a set of blind detection to be performed for the second control message,
a search space for detecting the second control message; and
an aggregation level for the second control message.

4. The method of claim 1, wherein the first control message includes one or more bits for indicating the first configuration information.

5. The method of claim 1, further comprising:
transmitting semi-static second configuration information for the second control message to the terminal device.

6. The method of claim 5, wherein the semi-static second configuration information for the second control message comprise at least one of:
a frequency and/or time location,
a modulation and coding scheme, MCS, and
a virtual resource to physical resource mapping.

7. The method of claim 1, wherein transmitting the first control message in a control resource region comprises:
transmitting the first control message on a plurality of control channel elements, CCEs, in the control resource region,
wherein an index of the first CCE of the plurality of CCEs indicates the first configuration information for detecting the second control message implicitly.

8. The method of claim 7, wherein
one of an odd index and an even index of the first CCE indicates that the second control message is scheduled by the first control message, and the other of the odd index and the even index of the first CCE indicates that a downlink or uplink data transmission is scheduled by the first control message.

9. The method of claim 7, wherein a result of the index of the first CCE modulo N indicate one or both of:
existence of the second control message, and
a configuration for the second control message,
wherein N is an integer larger than 2.

10. The method of claim 7, wherein the index of the first CCE of the plurality of CCEs indicates the first configuration information for detecting the second control message implicitly, only when the first control message is transmitted in a predetermined control resource set.

11. The method of claim 7, wherein transmitting the second control message in a data resource region comprises:
transmitting the second control message on a plurality of control channel elements, CCEs, in the data resource region,
wherein an index of the first CCE of the plurality of CCEs indicates a resource for a corresponding uplink feedback.

12. The method of claim 1, wherein the first control message further includes resource allocation information for the downlink or uplink data transmission for the terminal device.

13-32. (canceled)

33. A method in a terminal device, comprising:
receiving a first control message from a network device in a control resource region, the first control message having a predetermined size;
obtaining configuration information for detecting a second control message from the first control message, the configuration information indicating a set of antenna ports for detecting the second control message; and
detecting the second control message transmitted via the set of antenna ports of the network device in a data resource region at least partly based on the obtained configuration information, and
detecting downlink data or transmitting uplink data based on the detected second control message.

34. The method of claim 33, wherein the configuration information includes a first modulation and coding schemes, MCS, for a first resource, and a second MCS for a second resource; and
wherein detecting downlink data or transmitting uplink data comprises:
detecting the downlink data or transmitting the uplink data based on the first MCS in the first resource, and detecting the downlink data or transmitting the uplink data based on the second MCS in the second resource.

35. A method in a terminal device, comprising:
receiving a first control message from a network device in a control resource region, the first control message having a predetermined size which supports scheduling of two transport blocks for a downlink transmission, and including an configuration indication;
detecting a first transport block of the two transport blocks based on scheduling information for the first transport block included in the first control message; and
controlling detection of a second transport block of the two transport blocks based on the configuration indication.

36. The method of claim 35, wherein controlling detection of the second transport block of the two transport blocks based on the configuration indication comprises:
in response to the configuration indication having a first value, detecting a second control message from the second transport block; and
in response to the configuration indication having a second value, detecting data from the second transport block.

37. The method of claim 35, wherein controlling detection of the second transport block of the two transport blocks based on the configuration indication comprises:
in response to the configuration indication having a first value, detecting a second control message from the second transport block; and
in response to the configuration indication having a second value, preventing detecting the second transport block.

38-44. (canceled)
